(19) United States
(12) Patent Application Publication
(10) Pub. No.: US 2013/0290008 A1
(43) Pub. Date: Oct. 31, 2013

(54) STAFF ASSIGNMENT FOR CLINICAL TRIALS

(71) Applicant: John ROSENBLUM, Calais, VT (US)

(72) Inventor: John ROSENBLUM, Calais, VT (US)

(73) Assignee: ORACLE INTERNATIONAL CORPORATION, REDWOOD SHORES, CA (US)

(21) Appl. No.: 13/592,877

(22) Filed: Aug. 23, 2012

Related U.S. Application Data
(60) Provisional application No. 61/639,136, filed on Apr. 27, 2012.

(51) Int. Cl. G06Q 50/22

(52) U.S. Cl. 705/2

(57) ABSTRACT

Systems, methods, and other embodiments associated with a graphical user interface for scheduling clinical staff are described. In one embodiment, a method includes generating a schedule for a plurality of events. The plurality of events are events for one or more clinical studies. Generating the schedule includes defining an order and an amount of time for each event of the plurality of events. The method also includes automatically generating a graphical user interface (GUI) from the schedule by displaying the plurality of events on a timeline grouped into shifts. The GUI displays conflicts between the shifts.

### CROSS REFERENCE TO RELATED APPLICATIONS

This disclosure claims the benefit of U.S. Provisional Patent Application Ser. No. “61/639,136” filed Apr. 27, 2012, titled “A Clinical Resource Management System”, inventor: John Rosenblum, and assigned to the present assignee, and which is incorporated by reference herein in its entirety.

### COPYRIGHT NOTICE

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Before a new drug or treatment is approved for use it is tested. One way that new drugs and treatments are tested is through a series of clinical trials. Clinical trials may include many phases and forms of testing such as bioavailability (BA) and bioequivalence (BE) studies that provide information to practitioners about the safety and efficacy of a new drug/treatment. To perform these clinical trials, the pharmaceutical industry often uses clinical organizations.

The clinical organizations are corporations that run clinics which perform the testing for new drugs/treatments. The clinical organizations are dedicated to performing clinical trials where groups of subjects are dosed with new drugs and study data is collected based on a carefully timed set of clinical events. Study data may include analysis of human blood plasma, vitals exams, electrocardiograms, and clinical labs. All of the study data is gathered at specific times from when a subject is dosed to provide an accurate picture of how the drug affects the subject over time. Thus, performing a clinical trial includes gathering a large amount of study data that is used to track and analyze performance of the drug.

To perform this testing many trained staff members such as nurses, doctors, phlebotomists and so on perform procedures and collect the study data. Accordingly, the staff members must be scheduled and coordinated together to effectively perform the study. To do this, many clinics use a spreadsheet to manually determine schedules for staff. This results in an inefficient use of staff because optimal solutions are difficult to determine using manual schedule entry with a complicated set of scheduling parameters. In short, the clinics take a lot of time to do an inefficient job of scheduling. Additionally, because the schedules are contained in multiple and separate spreadsheets, it is difficult to share data with other tools, which could be used for administrative planning or communicating schedules to clinic staff.

The clinical organizations pay for clinic space and clinic staff regardless of how efficiently it is used. Thus, low utilization of clinical space and staff creates significant business problems for the clinical organizations.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a method associated with assigning clinical staff for clinical trials.

FIG. 2 illustrates one example screenshot of a graphical user interface shown with a staff assignment screen.

FIG. 3 illustrates one example of a screenshot of a graphical user interface shown with a chart of events in a shift for a staff member.

FIG. 4 illustrates one example of a screenshot of a graphical user interface shown with a schedule details screen.

FIG. 5 illustrates one example of a screenshot of a graphical user interface shown with an event schedule screen.

FIG. 6 illustrates one example of a screenshot of a graphical user interface shown with a new event types screen.

FIG. 7 illustrates one example of a screenshot of a graphical user interface shown with a new event screen.

FIG. 8 illustrates one example of a screenshot of a graphical user interface shown with a clinic screen.

FIG. 9 illustrates one example of a screenshot of a graphical user interface shown with an edit clinic screen.

FIG. 10 illustrates an embodiment of a computing system in which example systems and methods, and equivalents, may operate.

### DETAILED DESCRIPTION

Systems, methods and other embodiments are described that are associated with a graphical user interface for assigning clinical staff to shifts of a schedule. In one embodiment, a graphical user interface (GUI) generated by a computer automates generating and displaying schedules for staff members in a clinic. Consider that scheduling staff for clinical trials is a complex task that involves coordinating many different subjects and tasks. Subjects may be tested many different times using several different procedures.

For instance, a phlebotomist can draw blood from a different subject every two minutes. In this way, the phlebotomist can complete a clinical event for twenty four subjects in less than one hour (2 mins×24 Subjects=48 mins). However, the complexity of scheduling these clinical events quickly increases when considering that there may be fifty different events for each subject in a study. The events can include different procedures, such as, blood draws, vitals tests, electrocardiograms, meals, and so on. All of these events are completed during a study shift by as few as five staff members in some circumstances.

Additionally, several studies may operate in parallel in the same clinic. Thus the same staff may be scheduled to perform clinical events across multiple studies. Consequently, this intermingling of events, staff, and subjects complicates attempts to efficiently schedule staff using manual procedures. Thus in one embodiment, a graphical user interface (GUI) is configured to automate the generation of schedules while simplifying interaction with staff. In this way, scheduling many staff members between different events and clinical studies is improved.

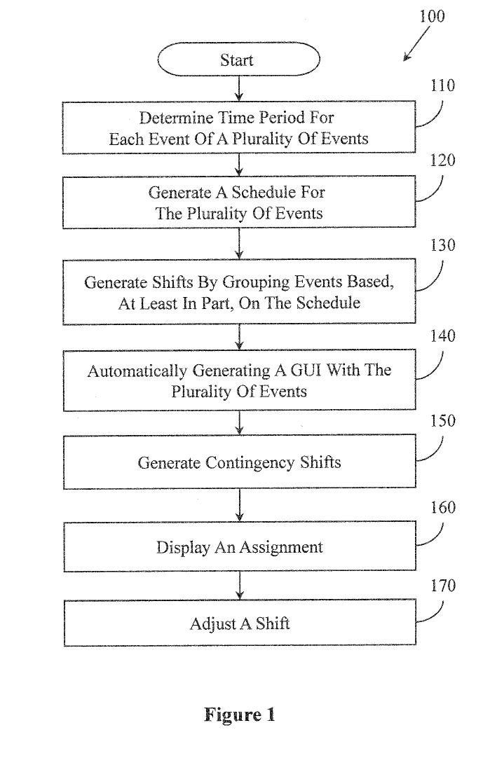

With reference to FIG. 1, one embodiment of a computer-implemented method 100 is illustrated that is associated with automatically generating schedules and displaying the schedules on a GUI. In one embodiment, method 100 is implemented by an application server, a computer, or other computing device.

Consider that a number of events have been defined and need to be scheduled. Method 100 begins at 110 by determining, in the computer, an amount of time for each event that needs to be scheduled. As previously mentioned, each clinical study includes many different events. An event is, for example, a repetition of a single task (e.g., dosing with a drug) for each subject in a study. Thus, the amount of time an event will consume is determined by the computer according to different variables before scheduling can occur.

For example, suppose a staff member is assigned to dose fifty subjects in a study. Each dose is spaced at an even interval from a previous dose. An interval is defined by a predetermined offset between tasks. The offset is a time value that can be specified in a clinical protocol that defines different operational values for different tasks and events (e.g., offsets, setup times, breakdown times, etc.).

Consider that an offset between doses is, for example, two minutes. Thus, if the staff member doses fifty subjects using a two minute offset, then the amount of time for the event is 100 minutes. For some events, tasks can be performed on a number of subjects in parallel. Thus, calculating the time for performing the tasks of an event can be determined according to: (number of subjects/number of tasks that can be performed in parallel)×offset. If, for example, two patients can be dosed in parallel, then the calculation becomes (50 subjects/2 in parallel)×2 mins=50 mins.

An event may also include a setup time and a breakdown time. The setup time is an amount of time necessary to prepare for performing the task on all of the subjects. The setup time may include time for setting up equipment, preparing doses, and so on. The breakdown time is an amount of time to clean up after performing all of the tasks in an event, a time to collate records taken during the event, other administrative tasks, and so on. In general, the setup time and the breakdown time are time periods for performing preparatory, administrative, and other duties associated with performing the actual tasks of the event.

In one embodiment, the setup and breakdown times are defined by a clinical protocol. Clinic staff can enter information about the clinical protocol into the computer to detail timeframes for each event type. Thus, times for the setup and breakdown can be taken from the computer (e.g., the method retrieves stored values from a storage device). As previously mentioned, the offset can also be specified by the clinical staff and is stored in a database or other data store and retrieved by the computer when determining an amount of time for each event. Once these times are known and information about the study is known (e.g., number of subjects), an amount of time for each event can be calculated by the computer.

With continued reference to FIG. 1, at 120, once an amount of time for each event has been determined, a schedule of all of the events is generated by the computer. In one embodiment, generating the schedule includes assigning the events to time slots during a day in which the events are to be performed. For example, assigning the events to times includes determining a correct order for the events and then specifying timeslots (e.g., 1:00 PM to 2:55 PM) for each event.

Additionally, scheduling for each study can be performed according to different criteria. In one example, scheduling the events can be based on zero times for the studies. The zero times are times when the dosing in the study is to occur. Thus, events are scheduled relative to the zero time of the study. For example, an event can be scheduled one hour prior to the zero time, one hour after the zero time, and so on.

In general, different studies are scheduled to avoid having the same zero time. In this way, for example, dosing events (or other events that occur at the same time relative to the zero time) for different studies can be scheduled at different times so that a single staff member can perform the dosing events or other events for more than one study. Accordingly, the zero time of a study can be provided as an input through the GUI or automatically determined by the GUI in order to avoid conflicts between studies.

After the schedule has been generated by the computer, at 120, the method 100 generates shifts, at 130, for assigning staff members to groups of events. A shift is a period of work for an employee that includes events to be performed by the employee. A shift can be generated by grouping multiple events that are to occur at different times together into a shift. The shifts may be grouped to avoid conflicts based on how they have been assigned in the schedule. That is, events that overlap or occur at the same time in the schedule are omitted from the same shift. In one embodiment, the computer groups similar events into the same shifts e.g., blood draw events, dosing events, vitals collection events, and so on. In this way, a staff member with a single skill set can be assigned to a shift. Additionally, shifts can include events scattered between different studies and different locations.

However, when generating a shift that includes multiple locations, the shifts also account for time to travel between locations so that delays do not occur when travel delays a staff member. In addition to the computer accounting for travel time, the computer may also account for other types of non-event related time that can influence the efficiency of a staff member. For example, time can be set aside for mandatory breaks (e.g., lunch), staff development, and so on.

Generating the shifts at 130 can also include generating the shifts according to different criteria, such as a specified number of available staff members, a minimum number of staff members, and so on.

At 140, the computer generates a graphical user interface (GUI) with the plurality of events. In one embodiment, the GUI displays the schedule of the plurality of events with the shifts on a timeline in order to provide an overview of staff scheduling. The display of the timeline is in the form of a Gantt chart or other graphic that displays the events in relation to time. The GUI can also include an indication of a staff assignment to individual events.

In one example, the GUI is automatically generated by the computer from the schedule once the schedule is complete. Alternatively, automatically generating the GUI occurs prior to generating the shifts in order to provide a display that used by an administrator to manually enter staff assignments and shifts. In general, the GUI displays shifts, events, and staff assignments in order to permit resolution of conflicts in the schedule. By providing a visual display, such as the GUI, conflicts can be easily visualized on the GUI and then resolved by a user.

in addition to the timeline, generating the GUI by the computer can include generating a plurality of displays. The displays can be displays used for many different purposes. For example, the displays can include a shift assignment display for modifying details of the shifts, a staff assignment display for modifying details of staff assignments to shifts, a staff display for modifying details of the staff, a create schedule display for modifying attributes of the schedule, an events display for modifying attributes of events in the plurality of events, an event schedule display for editing events of a clinical study, a “my schedule” display for displaying assignments of a shift for a staff member in a swim lane diagram, and/or a “my schedule” details display for displaying details of a “my schedule” display. Accordingly, the GUI may include many different displays that are used to modify and edit data in the computer about aspects of the schedule, staff, events, and so on.

Continuing with method 100, at 150, contingency shifts are generated by the computer. The contingency shifts are alternative shifts to the shifts generated at 130. Consider that the shifts generated at 130 are an optimal solution for assigning staff. However, contingency planning may be necessary because of conflicts that arise in the optimal solution due to, for example, changes in availability of staff, clinic space, equipment, and so on. Therefore, at 150, contingency shifts can be generated to account for “what if” circumstances.

Generating the contingency shifts includes grouping events from the schedule using different criteria than those used to generate the optimal solution. For example, instead of eight hour shifts one contingency set of shifts can be generated based on four hour shifts. Alternatively, contingency shifts can be generated using a different number of available staff. Contingency shifts can also be generated through a manual manipulation of the optimal solution by an administrative user. Each set of contingency shifts account for different intervening circumstances that can influence the schedule. In this way, the contingency shifts avoid difficulties with last minute changes by providing plans for handling events that effect the schedule.

At 160, the computer displays staff assignments for each of the shifts generated at 130 on the GUI. In one embodiment, the assignments are displayed according to an assignment input received through the GUI. For example, an administrative user can select a staff member for each shift using the GUI. Alternatively, the assignments are generated and displayed automatically according to available staff. More generally, staff members are assigned to shifts and then the assignments are displayed on the GUI in order to provide a visual indication of the assignments to a user. In this way, conflicts between shifts can be visualized through the GUI.

At 170, the computer adjusts a shift according to an adjustment input. Adjusting the shifts can occur in order to resolve any conflicts between assignments of staff to shifts as displayed at 160. The GUI can be used by an administrative user to provide the adjustment input. For example, the adjustment input can be provided through the GUI using a touch screen tablet or similar device. In this way, generating the schedule and assigning staff members to shifts is improved.

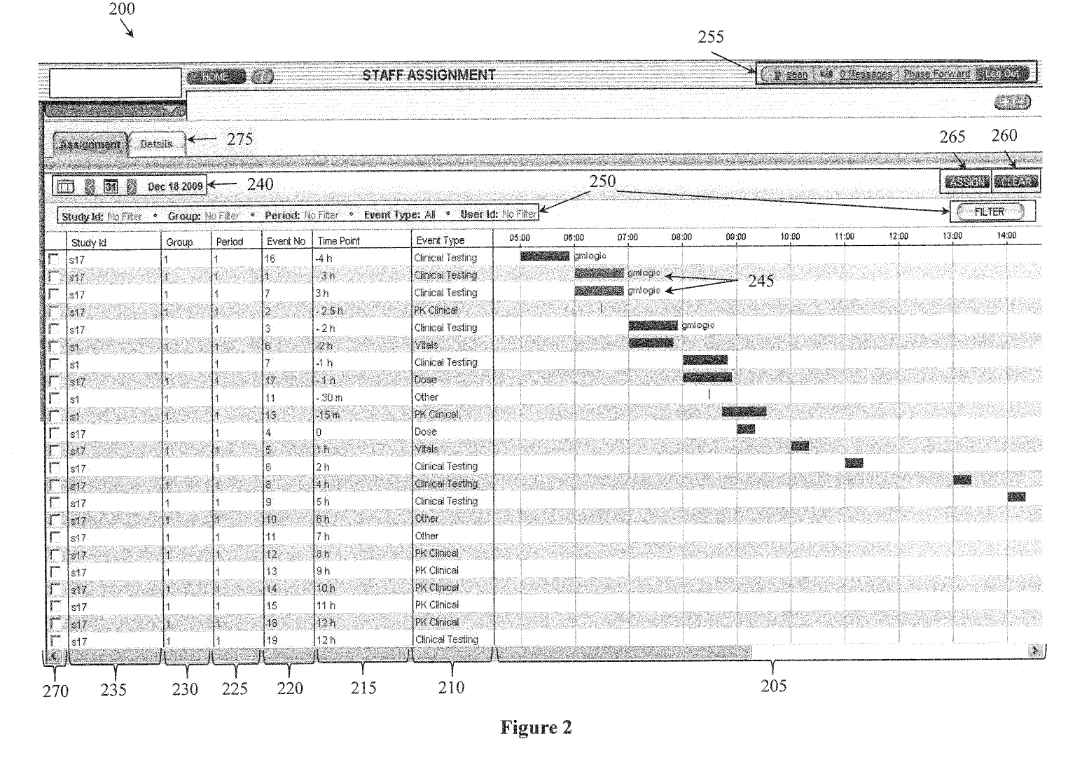

FIG. 2 illustrates an example screenshot of the GUI shown with a staff assignment screen 200 that includes a timeline 205. Columns illustrated in FIG. 2 include, the timeline 205, an event type column 210, a time point column 215, an event number column 220, a period column 225, a group column 230, and a study ID column 235. The event type column 210 identifies a type (e.g., vitals, testing, etc.) for an event in a corresponding row. The time point column 215 identifies a zero time and an offset from the zero time for events or a name for this event. The Event number column 220 displays a unique id number for each event of a study. The period column 225 displays which period of a study a selected group is undergoing. That is, a study may have several periods during which different testing occurs. Thus, the period column 225 identifies a period for an event of a study. The group column 230 displays a current subject group for an event. The study id column 235 displays a unique id number for each study.

A date and selectors for the date are illustrated in the box labeled 240. Using the selectors of box 240 a day displayed on the timeline can be changed to a different day. For example, currently the staff assignment screen 200 displays the timeline 205 for Dec. 18, 2009. However, by selecting a next arrow in the box 240 the GUI displays a timeline for Dec. 19, 2009. By default, the day that the GUI displays is a current day when a user logs into the staff assignment screen 200.

The timeline 205 illustrates a plurality of events along a time schedule (05:00 to 14:00 shown at the top of the column). Each row corresponds to an event with time periods for the events in the timeline 205 shown in the form of bars (e.g., bars 245) in a Gantt chart. Displaying the events in a Gantt chart illustrates an amount of time consumed for each event and when it is scheduled.

In the timeline 205, several events are assigned to a staff member identified as “gmlogic.” The events assigned to “gmlogic” are events of the same shift. Events 245 illustrate how a conflict can occur between events in a shift. Because the events 245 conflict they are displayed in red or with some other distinguishing highlight to denote the conflict. In general, a conflict occurs when bars overlap in a column and are also simultaneously assigned to a single staff member. In one embodiment, the conflict between the events 245 can be resolved through a user input that reassigns “gmlogic” from at least one of the events 245.

While the staff assignment screen 200 is illustrated with columns 205-235, in other embodiments, the staff assignment screen 200 can include different columns. The staff assignment screen 200 is also configured to provide information in response to a mouse over. That is, when a mouse cursor moves over, for example the conflicting bars 245, information is displayed about those events. The information can include a start time, an end time, information about subjects associated with the event, information about candidate staff members than can be assigned to the event to resolve the conflict, and so on.

Additionally, events displayed on the timeline 205 can be filtered using controls 250. For example, events for specific studies can be filtered using the study id option in the controls 250. The controls 250 also permit filtering displayed events according to group, period, user id, and event type. By using the controls 250 to filter events displayed in the staff assignment screen 200, events relevant to a particular study, user, or group are displayed. In addition to filtering the events, the events can be sorted. By default, rows are sorted in ascending order according to an earliest scheduled event to a last scheduled event. However, by selecting any column header in the GUI, the events can be sorted in ascending/descending order according to values in that particular column.

User links 255 permit a user to login, check mail messages, check user settings, logout, and so on. The user links 255 in FIG. 2 display links for an administrative user named “Sean.” In FIG. 2, the current user “Sean” has administrative rights as evidenced by the presence of administrative tools such as a clear option 260, an assign option 265, and check boxes 270. The check boxes 270 permit an administrative user to select an event row for editing. The clear option 260 clears all shift assignments for events that have been checked in the check column 270. The assign option 265 displays a shift assignment popup screen for events that have been checked.

The shift assignment popup screen is an editing screen that includes options for assigning staff to selected events from the staff assignment screen 200 of FIG. 2. The shift assignment popup screen includes a list of all available staff for selected events. Staff can be assigned to particular events using drop down menus that display staff names next to each event. Selected staff assignments can be saved using a “save” button. If conflicts exist upon selecting the save button an error dialog button can be displayed notifying a user of the conflict.

Additionally, correction of a conflict can be mandatory by requiring a user to correct the conflict prior to permitting them to leave the shift assignment popup screen. Other than notifying a user of conflicts, the shift assignment popup screen can be configured to provide notifications for staff members assigned to a shift that is longer than eight hours or if the shift exceeds other predefined criteria (e.g., no lunch break).

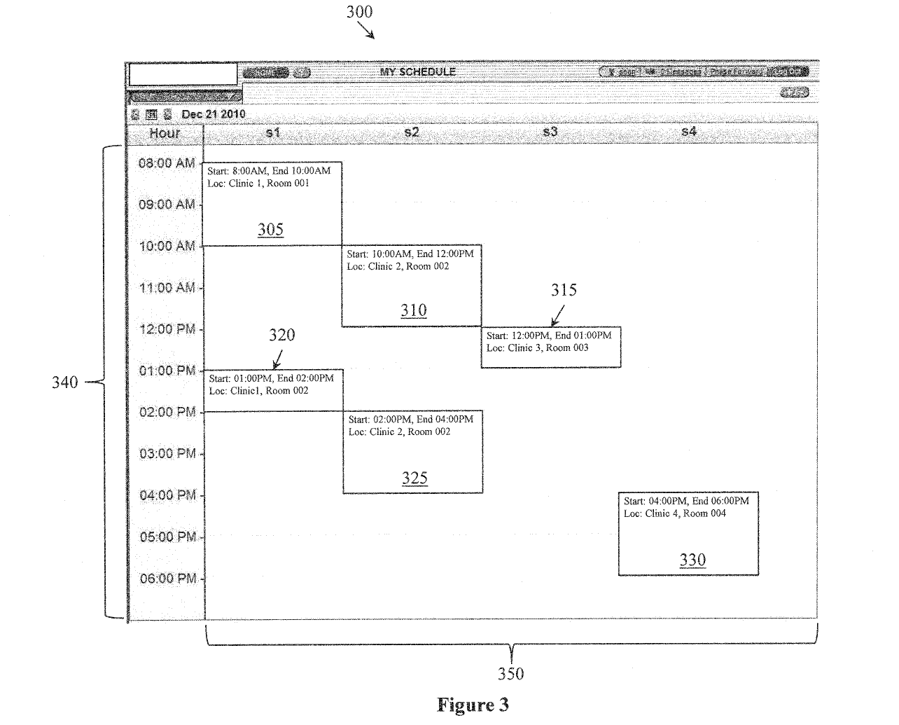

After a staff member has been assigned to a shift, a “my schedule” screen 300, as illustrated in FIG. 3, is available for display in the GUI by the computer. The “my schedule” screen 300 illustrates a swim lane style chart with an overview of events in a shift for a single staff member. The “my schedule” screen 300 displays events 305, 310, 315, 320, 325, and 330. The events 305, 310, 315, 320, 325, and 330 are events of a single shift and the display of these events includes information about each event. For example, a display of event 305 includes a start time, an end time, and a location of where the event is to be conducted. The events 305, 310, 315, 320, 325, and 330 are displayed against a y-axis 340 that denotes timeframes and an x-axis 350 that denotes to which study an event belongs. In one embodiment, the events 305, 310, 315, 320, 325, and 330 can be color coordinated according to a location of the event, a type of the event, and/or a study associated with the event.

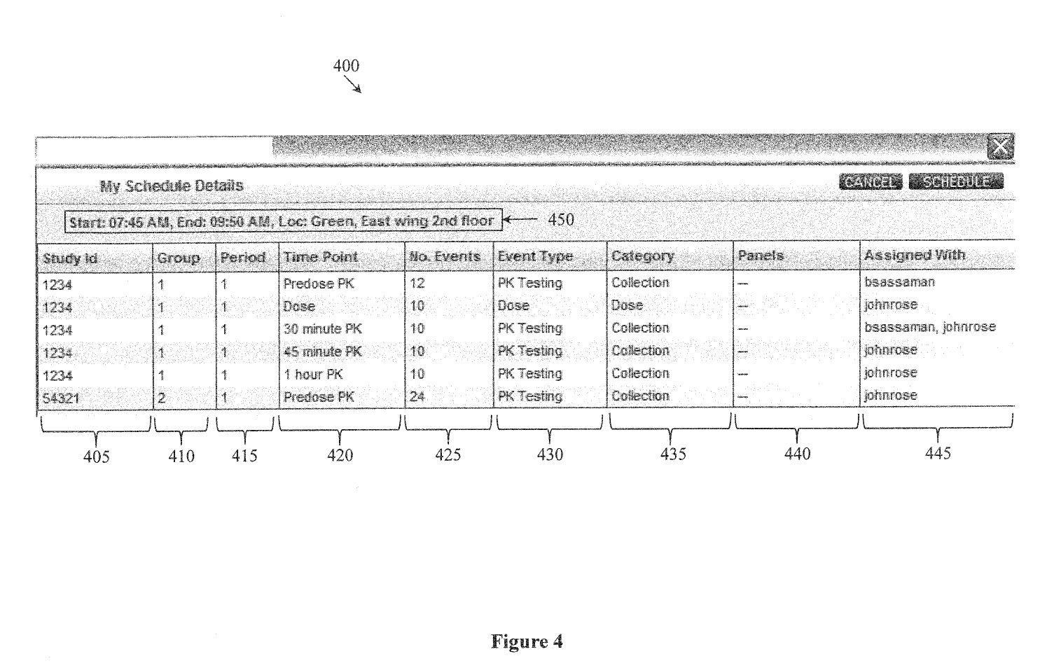

FIG. 4 illustrates one embodiment of a “my schedule” details screen 400 of the GUI. The “my schedule” details screen displays information about a single event block (e.g., event 305, 310, 315, 320, 325, or 330 of FIG. 3). The single event block is displayed on the “my schedule” details screen 400 with overview information about the event. The screen 400 includes a study id column 405, a group column 410, a period column 415, a time point column 420, a number of events column 425, an event type column 430, a category column 435, a panels column 440, and an assigned with column 445. The assigned with column 445 identifies other staff members that are also assigned to the same event or study as the staff member logged into and viewing the “my schedule” details screen 400. Box 450 includes a time and location for an event displayed on the screen 400. The “my schedule” details screen 400 can be accessed by a user selecting one of the events from the “my schedule” screen 300 of FIG. 3. Selecting one of the events can occur via a mouse cursor input, a touch screen input, and so on.

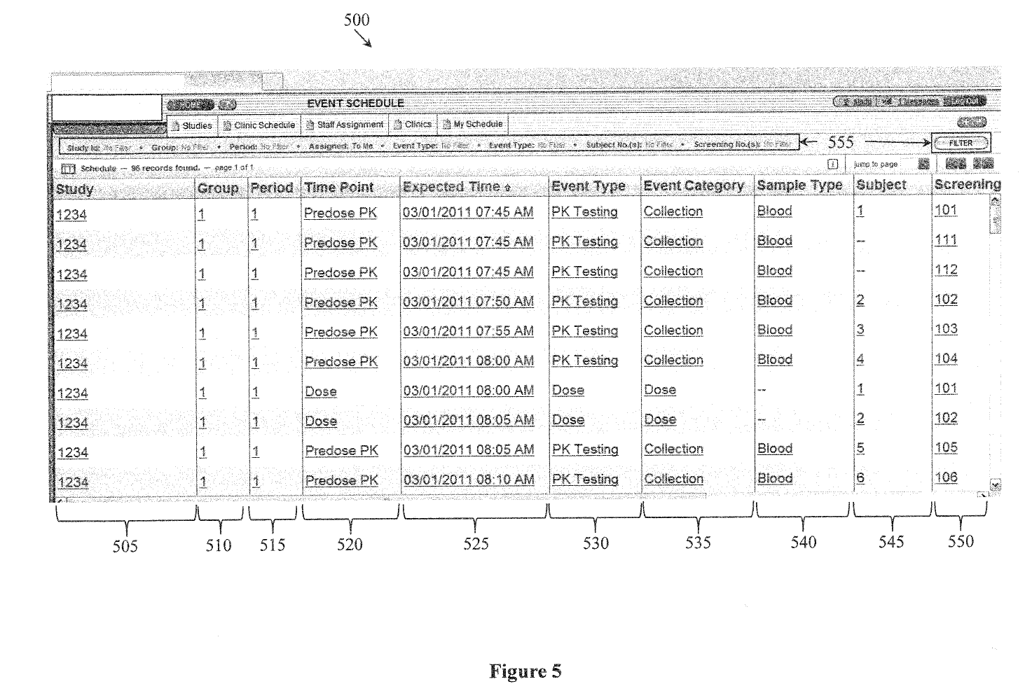

FIG. 5 illustrates an event schedule 500 of the GUI that is displayed by the computer in response to selecting a row on the screen 400 or an event from the “my schedule” screen 300 of FIG. 3. The event schedule 500 displays timing information for individual tasks in an event. Each task can include the following columns: a study id column 505, a group column 510, a period column 515, a time point column 520, an expected time column 525, an event type column 530, an event category column 535, a sample type column 540, a subject 545, and/or a screening column 550.

Selecting a row displays a separate screen for inputting data collected regarding the specific task of the row. The expected time column 525 is the time at which the task is expected to be performed. Tasks listed on the screen 500 have an offset (i.e., interval between tasks) of five minutes as reflected in values of the expected time column 525. The event type column 530, the event category column 535, and the sample type column 540 provide information on the task being performed. The event schedule screen 500 also includes filtering options 555 for changing which tasks are displayed. The tasks can also be sorted by selecting a column header name (e.g., “Expected Time” of the expected time column 525).

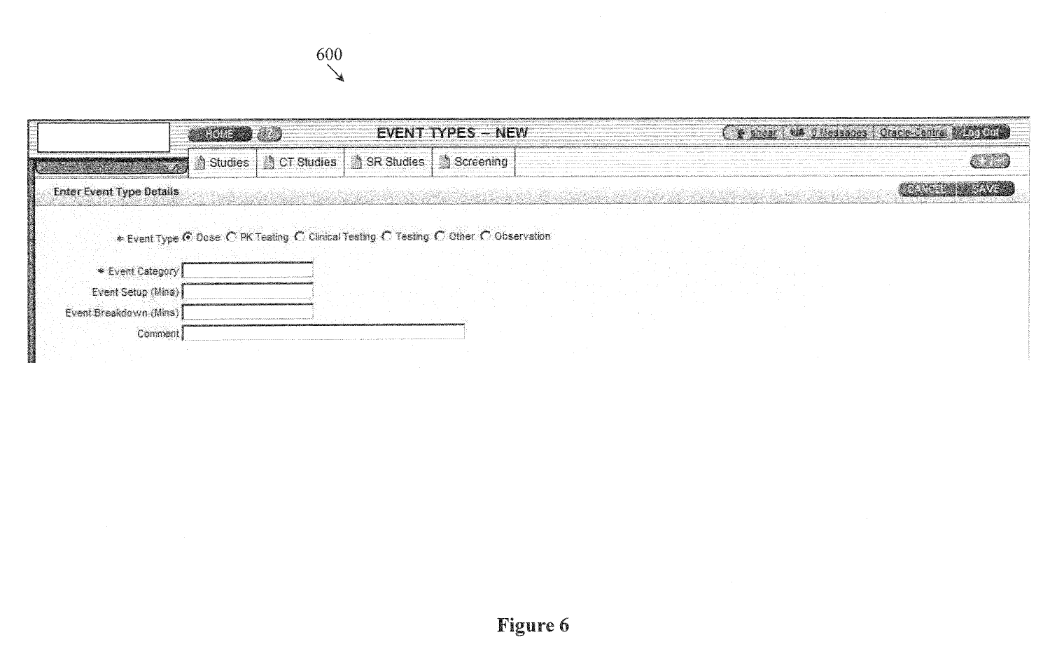

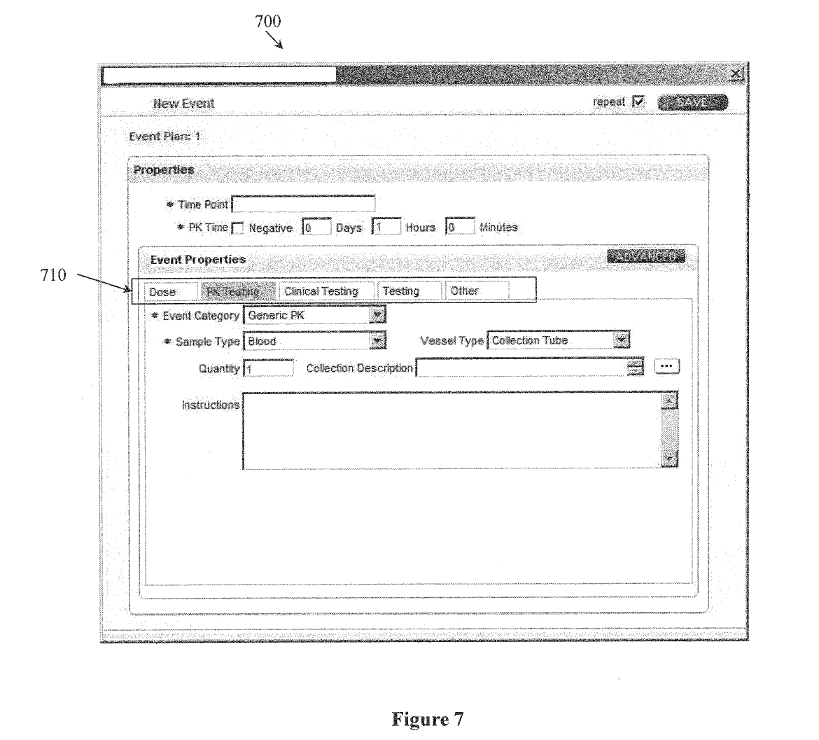

FIGS. 6-9 are displays of the GUI, generated by the computer, that are associated with configuring information used in display screens of FIGS. 2-5. For example, FIG. 6 illustrates a new event types screen 600. The new event types screen is used for defining new event types that can then be used when adding events to studies and schedules. The new event types screen 600 shows five different attributes for an event type. The attributes include an event type, an event category, an event setup time, an event breakdown time, and a comment field. The event type is shown as a radio button selection; however, the event type may also be a text field. Additionally, while the other attributes are shown as text fields, other types of fields such as drop down menus, radio buttons, lists, and so on can be used. Once information for the different attributes on the new event types screen 600 is filled-in, selecting “save” defines a new event type with the newly defined attributes. The new event type can then be used when defining new events as shown with FIG. 7.

FIG. 7 illustrates a new event screen 700. As illustrated in FIG. 7, the new event screen 700 is a popup window. The new event screen 700 includes fields for providing attributes for defining a new event. For example, in FIG. 7, the new events screen 700 includes a time point attribute and a PK time attribute. Tabs 710 provide selections for different event types. Each event type includes different attributes. In FIG. 7, the “PK testing” event type is selected and thus attributes for this event type are displayed so that they may be filled-in. Fields with an asterisk (*) are required fields. If the required fields are not filled-in, then the new event will not be saved and an error message is displayed when the “save” button is selected. In one embodiment, values provided in the fields can be checked to determine if they comply with predefined constraints. If the values do not comply, an error message can be displayed.

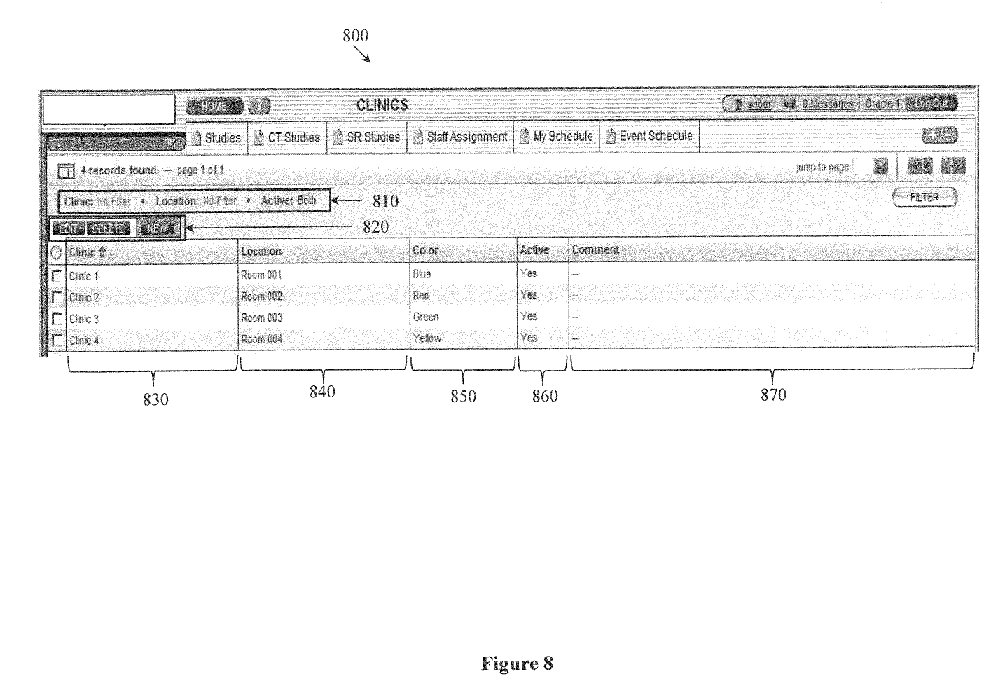

FIG. 8 illustrates an example screenshot of a clinic screen 800. The clinic screen 800 is used for editing, deleting, and adding clinics that are used to generate schedules. The clinic screen 800 includes controls such as filter options 810 and modify buttons 820. The clinics are displayed on the clinic screen 800 in a column and row format with the columns including a clinic name 830, a location 840, a color 850, an active status 860, and a comment column 870. The color 850 defines a color for a clinic when displaying an event block on the “my schedule” screen 300 of FIG. 3 for an event that is scheduled in the clinic. To delete a clinic, a corresponding checkbox in a row of the clinic is first selected. After the checkbox has been selected, selecting the delete button performs the operation for the selected clinic(s).

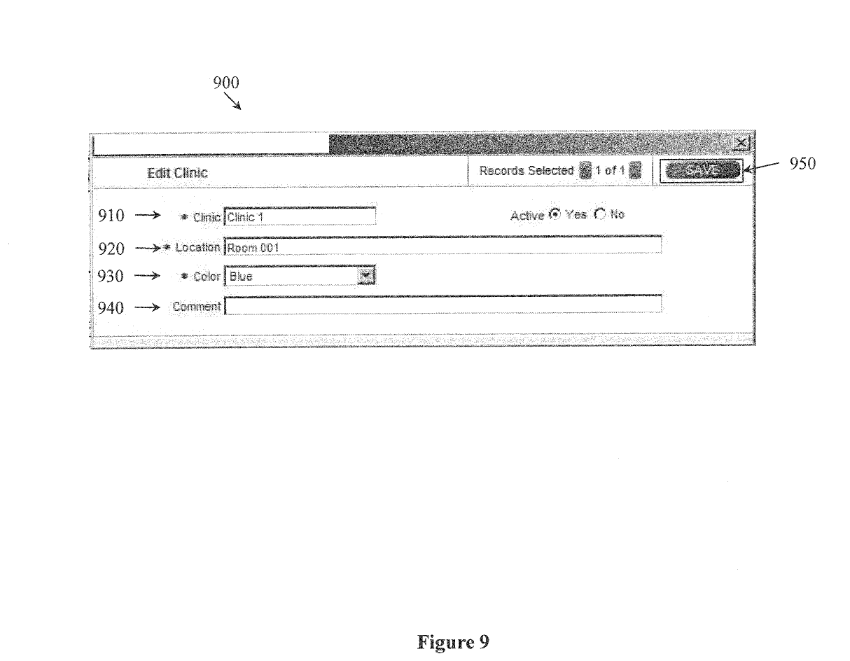

In a similar fashion, selecting the edit button or the new button from the controls 820 initiates an edit clinic screen 900, as shown in FIG. 9. The edit clinic screen 900 permits editing of clinics currently available on the clinics screen 800 and adding new clinics. Attributes shown in edit screen 900 include a clinic name 910, a clinic location 920, a color 930 for displaying the clinic on the “my schedule” screen 300 of FIG. 3, and a comment field 940. Selecting save button 950 saves any edits.

FIGS. 2-9 illustrate examples of available screens of the GUI. In other embodiments, the GUI can include fewer or more screens than those depicted in FIGS. 2-9. For example, in one embodiment, the GUI includes screens as depicted in FIGS. 2-5 but not screens depicted in FIGS. 6-9. Additionally, the GUI may include screens similar to those shown in FIGS. 2-9 but with elements that differ or elements that are personalized for different clinics and or staff members.

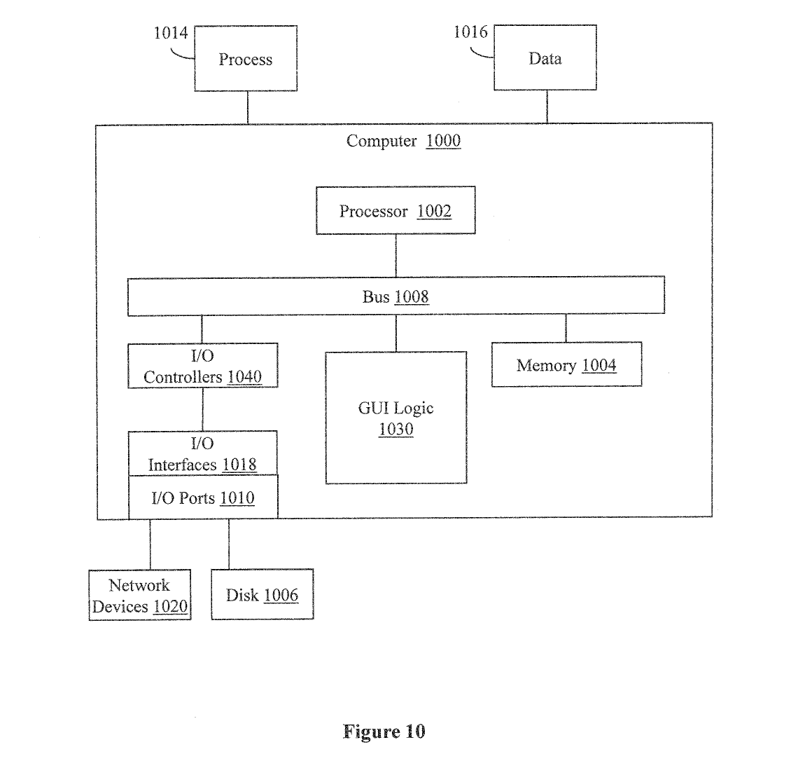

FIG. 10 illustrates an example computing device in which example systems and methods described herein, and equivalents, may operate. The example computing device may be a computer 1000 that includes a processor 1002, a memory 1004, and input/output ports 1010 operably connected by a bus 1008. In one example, the computer 1000 may include a graphical user interface (GUI) logic 1030 configured to generate a GUI by generating a schedule for a plurality of events and automatically generating a staff assignment from the schedule. In different examples, the logic 1030 may be implemented in hardware, a non-transitory computer-readable medium with stored instructions, firmware, and/or combinations thereof. While the logic 1030 is illustrated as a hardware component attached to the bus 1008, it is to be appreciated that in one example, the logic 1030 could be implemented in the processor 1002.

Generally describing an example configuration of the computer 1000, the processor 1002 may be a variety of various processors including dual microprocessor and other multi-processor architectures. A memory 1004 may include volatile memory and/or non-volatile memory. Non-volatile memory may include, for example, ROM, PROM, and so on. Volatile memory may include, for example, RAM, SRAM, DRAM, and so on.

A disk 1006 may be operably connected to the computer 1000 via, for example, an input/output interface (e.g., card, device) 1018 and an input/output port 1010. The disk 1006 may be, for example, a magnetic disk drive, a solid state disk drive, a floppy disk drive, a tape drive, a Zip drive, a flash memory card, a memory stick, and so on. Furthermore, the disk 1006 may be a CD-ROM drive, a CD-R drive, a CD-RW drive, a DVD ROM, and so on. The memory 1004 can store a process 1014 and/or a data 1016, for example. The disk 1006 and/or the memory 1004 can store an operating system that controls and allocates resources of the computer 1000.

The bus 1008 may be a single internal bus interconnect architecture and/or other bus or mesh architectures. While a single bus is illustrated, it is to be appreciated that the computer 1000 may communicate with various devices, logics, and peripherals using other busses (e.g., PCIE, 1394, USB, Ethernet). The bus 1008 can be types including, for example, a memory bus, a memory controller, a peripheral bus, an external bus, a crossbar switch, and/or a local bus.

The computer 1000 may interact with input/output devices via the i/o interfaces 1018 and the input/output ports 1010. Input/output devices may be, for example, a keyboard, a microphone, a pointing and selection device, cameras, video cards, displays, the disk 1006, the network devices 1020, and so on. The input/output ports 1010 may include, for example, serial ports, parallel ports, and USB ports.

The computer 1000 can operate in a network environment and thus may be connected to the network devices 1020 via the i/o interfaces 1018, and/or the i/o ports 1010. Through the network devices 1020, the computer 1000 may interact with a network. Through the network, the computer 1000 may be logically connected to remote computers. Networks with which the computer 1000 may interact include, but are not limited to, a LAN, a WAN, and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium”, as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

In some examples, “database” is used to refer to a table. In other examples, “database” may be used to refer to a set of tables. In still other examples, “database” may refer to a set of data stores and methods for accessing and/or manipulating those data stores.

“Logic”, as used herein, includes but is not limited to hardware, firmware, a non-transitory computer readable medium that stores instructions, and/or combinations of each to perform a function(s) or an action(s), and/or to cause a function or action from another logic, method, and/or system. Logic may include a microprocessor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

While example systems, methods, and other embodiments have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A non-transitory computer-readable medium storing computer-executable instructions that when executed by a computer cause the computer to perform a method, the method comprising:
generating, using at least a processor, a schedule for a plurality of events, wherein the plurality of events are events for one or more clinical studies, wherein generating the schedule includes defining an order and an amount of time for each event of the plurality of events; and
automatically generating, using at least the processor, a graphical user interface (GUI) from the schedule by displaying, on a display of the computer, the plurality of events on a timeline grouped into shifts, and wherein the GUI displays conflicts between the shifts.

2. The non-transitory computer-readable medium of claim 1, wherein the shifts are periods of work for staff, wherein automatically generating the GUI includes displaying the plurality of events on the timeline based, at least in part, on a zero time for each of the one or more clinical studies and an offset time for each of the plurality of events, wherein the zero time is a time when dosing for a clinical study begins, and wherein the offset time is a time between tasks during an event.

3. The non-transitory computer-readable medium of claim 2, further comprising:
prior to generating the GUI, determining a time period for performing tasks of each event of the plurality of events based, at least in part, on a clinical protocol and attributes of a clinical study of the one or more clinical studies for each event, wherein the clinical protocol defines an offset time between tasks of an event.

4. The non-transitory computer-readable medium of claim 1, further comprising:
prior to generating the GUI, generating the shifts by grouping events of the plurality of events based, at least in part, on the schedule, wherein each shift includes at least one of the plurality of events, and wherein generating the shifts includes generating the shifts to use a minimum number of staff;
displaying an assignment of a staff member of the staff to each of the shifts according to an assignment input received through the GUI; and
adjusting a shift of the shifts according to an adjustment input to resolve the conflicts, wherein the adjustment input is received through the GUI.

5. The non-transitory computer-readable medium of claim 1, wherein attributes of the one or more clinical studies include a list of events for each of the clinical studies and a number of subjects for each of the clinical studies, and wherein the GUI includes a window for entering information about each event.

6. The non-transitory computer-readable medium of claim 1, wherein the timeline is a Gantt chart.

7. The non-transitory computer-readable medium of claim 1, wherein generating the schedule includes calculating the schedule to use a minimum number of staff.

8. The non-transitory computer-readable medium of claim 1, further comprising:
generating contingency shifts to provide alternative shifts for assigning staff.

9. The non-transitory computer-readable medium of claim 1, wherein generating the GUI includes generating one or more user interface displays on the display of the computer, wherein the one or more user interface displays include one or more of:
a shift assignment display for modifying details of the shifts,
a staff assignment display for modifying details of staff assignments to shifts,
a staff display for modifying details of the staff,
a create schedule display for modifying attributes of the schedule,
an events display for modifying events in the plurality of events, wherein modifying an event includes editing the event, deleting the event, or adding the event,
a clinic display for modifying information about clinics, wherein a clinic is a location for one of the one or more clinical studies, wherein modifying a clinic includes editing information about the clinic, deleting information about the clinic, or adding information about the clinic,
an event schedule display for editing events included in a clinical study,
a schedule display for displaying events of a shift for a staff member in a swim lane chart, and
a schedule details display for displaying details of an event from the schedule display.

10. A system for providing a graphical user interface (GUI), the system comprising:
a GUI logic implemented in hardware and configured to generate the graphical user interface (GUI) that includes a plurality of displays, wherein the GUI logic is configured to generate the plurality of displays by:
generating a schedule for a plurality of events, wherein the plurality of events are events for one or more clinical studies, wherein generating the schedule includes defining an order and an amount of time for each event of the plurality of events, and
automatically generating a staff assignment display that includes a timeline with the plurality of events grouped into shifts, wherein the timeline is generated from the schedule, and wherein the staff assignment display visually indicates where conflicts occur between the shifts on the timeline.

11. The system of claim 10, wherein the GUI logic is configured to automatically generate the staff assignment display by displaying the plurality of events on the timeline based, at least in part, on a zero time for each of the one or more clinical studies and an offset time for each of the plurality of events, wherein the zero time is a time when dosing for a clinical study begins, and wherein the offset time is a time between tasks during an event.

12. The system of claim 10, wherein the GUI logic is configured to display on the timeline an assignment of a staff member to each of the shifts according to an assignment input received through the GUI,
wherein the GUI logic is configured to adjust a shift of the shifts according to an adjustment input to resolve the conflicts, wherein the adjustment input is received through the GUI, and
wherein the GUI logic is configured to generate contingency shifts to provide alternative shifts for assigning staff members.

13. The system of claim 10, wherein the GUI logic is configured to generate the schedule based, at least in part, on using a minimum number of staff members.

14. The system of claim 10, wherein the timeline is a Gantt chart.

15. A method implemented by a computer, the method comprising:
determining, using at least a processor from the computer, a time period for performing tasks of each event of a plurality of events based, at least in part, on a clinical protocol and attributes of a clinical study for each event, wherein the plurality of events are events for one or more clinical studies;
generating, using at least the processor, a schedule for the plurality of events, wherein generating the schedule includes defining an order the plurality of events and storing the schedule in a non-transitory computer-readable medium; and
automatically generating, using at least the processor, a graphical user interface (GUI) from the schedule by displaying the plurality of events on a Gantt chart grouped into shifts, and wherein the Gantt chart displays conflicts between the shifts.

16. The method of claim 15, wherein automatically generating the GUI includes displaying the plurality of events on the timeline based, at least in part, on a zero time for each of the one or more clinical studies and an offset time for each of the plurality of events, wherein the zero time is a time when dosing for a clinical study begins, and wherein the offset time is a time between tasks during an event that is defined by the clinical protocol.

17. The method of claim 15, further comprising:
displaying an assignment of a staff member of the staff to each of the shifts according to an assignment input received through the GUI; and
adjusting a shift of the shifts according to an adjustment input to resolve the conflicts, wherein the adjustment input is received through the GUI and displayed on the GUI.

18. The method of claim 15, wherein generating the GUI includes generating a plurality of displays for controlling attributes of the schedule.

19. The method of claim 15, wherein attributes of the one or more clinical studies include a list of events for each of the clinical studies and a number of subjects for each of the clinical studies.

20. The method of claim 15, further comprising:
generating contingency shifts to provide alternative shifts for assigning staff.
